(19) United States
(12) Patent Application Publication
(10) Pub. No.: US 2026/0204210 A1
(43) Pub. Date: Jul. 16, 2026

(54) IMAGE COMPENSATION METHOD AND APPARATUS, COMPUTER DEVICE, COMPUTER-READABLE STORAGE MEDIUM, AND COMPUTER PROGRAM PRODUCT

(71) Applicant: GLENFLY TECH CO., LTD., Shanghai (CN)

(72) Inventors: Jianhong PAN, Shanghai (CN); Long HUANG, Shanghai (CN); Chaohai CHANG, Shanghai (CN)

(21) Appl. No.: 19/324,971

(22) Filed: Sep. 10, 2025

(30) Foreign Application Priority Data
Jan. 10, 2025 (CN) 202510045134.3

(51) Int. Cl. G09G 3/3225

(52) U.S. Cl. CPC G09G 3/3225; G09G 2320/0233; G09G 2320/0242; G09G 2320/045; G09G 2340/02; G09G 2360/16

(57) ABSTRACT

Image compensation method and apparatus, a computer device, a computer-readable storage medium, and a computer program product are provided. The method includes: obtaining a to-be-processed image, the to-be-processed image carrying accumulated stress values of each pixel in different channels; obtaining luminance decay degree values of each pixel in different channels based on the accumulated stress values; and calculating a compensation factor for each pixel based on the luminance decay degree values of each pixel in different channels, and compensating each pixel according to the compensation factor. The method can accurately provide compensation to images.

### CROSS-REFERENCE TO RELATED APPLICATION

This application claims priority to Chinese Patent Application No. 202510045134.3, filed with CNIPA on Jan. 10, 2025, entitled “IMAGE COMPENSATION METHOD AND APPARATUS, COMPUTER DEVICE, COMPUTER-READABLE STORAGE MEDIUM, AND COMPUTER PROGRAM PRODUCT”, the entire contents of which are incorporated herein by reference.

### TECHNICAL FIELD

This application relates to the technical field of Active Matrix Organic Light-Emitting Diode (AMOLED), and in particular, to an image compensation method, an image compensation apparatus, a computer device, a computer-readable storage medium, and a computer program product.

### BACKGROUND

With the rapid development of display technology, the Active Matrix Organic Light-Emitting Diode (AMOLED) display technology has gradually become the mainstream. This technology is widely used in smart phones, televisions, wearable devices and other fields due to its advantages such as self-luminous characteristics, high contrast, wide viewing angle and low power consumption. However, the self-luminous characteristics of the AMOLED panel also introduce some new technical challenges, especially due to the limitation of the service life of the organic light-emitting material, its electrical characteristics will gradually degrade as the light-emitting time increases, resulting in non-uniformity of luminance and color between pixels.

In the AMOLED display technology, the luminance of a pixel is controlled by an independent organic light-emitting diode, and the decay speeds of respective pixels are different due to different workloads and different environmental factors. Especially when a fixed image is displayed for a long time, some pixels are accelerated to age due to continuous light emission, which will cause “image sticking” phenomenon, that is, the image leaves “stuck image” on the screen; and even after the display content is changed, the stuck image is still visible, which seriously affects user visual experience.

At present, the above problems are solved by means of pixel equalization, timed refresh and full-screen movement, however, the image still cannot be accurately compensated.

### SUMMARY

In view of the above, it is necessary to provide an image compensation method, an image compensation apparatus, a computer device, a computer-readable storage medium and a computer program product, which can accurately compensate images.

In a first aspect, the present application provides an image compensation method, where the method includes:
obtaining a to-be-processed image, the to-be-processed image carrying accumulated stress values of each pixel in different channels;
obtaining luminance decay degree values of each pixel in different channels based on the accumulated stress values; and
calculating a compensation factor for each pixel based on the luminance decay degree values of each pixel in different channels, and compensating each pixel according to the compensation factor.

In an embodiment, obtaining the luminance decay degree values of each pixel in different channels based on the accumulated stress values includes:
obtaining preset lookup tables corresponding to different channels, where each preset lookup table is generated based on a relationship between historical accumulated stress values and current luminance decay degrees; and
separately querying, based on the accumulated stress values, the preset lookup tables corresponding to different channels, to obtain the luminance decay degree values of each pixel in different channels.

In an embodiment, calculating the compensation factor for each pixel based on the luminance decay degree values of each pixel in different channels, and compensating each pixel according to the compensation factor include:
determining a display status of each pixel based on the luminance decay degree values of each pixel in different channels;
in a case that the display status is that there exists a color offset, calculating a decay difference of each pixel in different channels, using the decay difference as the compensation factor, and performing color offset compensation on each pixel according to the compensation factor; and
in a case that the display status is that there exists a luminance decay, obtaining a target luminance value, using the target luminance value as the compensation factor, and performing luminance compensation on each pixel according to the compensation factor.

In an embodiment, calculating the decay difference of each pixel in different channels, using the decay difference as the compensation factor, and compensating each pixel according to the compensation factor include:
determining a maximum decay channel and a minimum decay channel based on the luminance decay degree values of each pixel in different channels;
calculating the decay difference based on the maximum decay channel and the minimum decay channel; and
compensating a luminance value corresponding to the maximum decay channel based on the decay difference, to cause the luminance decay degree value of the maximum decay channel to be consistent with the luminance decay degree value of the minimum decay channel.

In an embodiment, using the target luminance value as the compensation factor and performing luminance compensation on each pixel according to the compensation factor include:
compensating luminance values of each pixel in different channels based on the target luminance value.

In an embodiment, a process of determining the display status includes:
in a case that a maximum luminance decay degree value is less than a preset threshold and a difference between the maximum luminance decay degree value and a minimum luminance decay degree value is greater than a difference threshold, or in a case that the maximum luminance decay degree value is greater than the preset threshold and the minimum luminance decay degree value is less than the preset threshold, determining that the display status is that there exists the color offset;
in a case that both the maximum luminance decay degree value and the minimum luminance decay degree value are greater than or equal to the preset threshold, determining that the display status is that there exists the luminance decay.

In an embodiment, the to-be-processed image is obtained by decompressing compressed image data, and the compressed image data comprises a partition length and a segment accumulated stress value that correspond to a target pixel block partition in each channel; and before separately querying, based on the accumulated stress values, the preset lookup tables corresponding to different channels, the method further includes:
decompressing the compressed image data based on the partition length and the segment accumulated stress value, to obtain accumulated stress values of respective pixels in each channel.

In an embodiment, a compression process to obtain the compressed image data includes:
obtaining original image data;
dividing the original image data into blocks to obtain multiple pixel blocks;
calculating average accumulated stress values of each pixel block in different channels based on the accumulated stress values of respective pixels in each pixel block in different channels;
merging the pixel blocks in different channels based on the average accumulated stress values of each pixel block in different channels, to obtain target pixel block partitions in different channels and segment accumulated stress values corresponding to the target pixel block partitions; and
performing compression based on numbers of pixel blocks corresponding to the target pixel block partitions in different channels and the segment accumulated stress values corresponding to the target pixel block partitions in different channels, to obtain the compressed image data.

In an embodiment, merging the pixel blocks in different channels based on the average accumulated stress values of each pixel block in different channels, to obtain the target pixel block partitions in different channels and the segment accumulated stress values corresponding to the target pixel block partitions includes:
calculating, in a first direction, an accumulated stress difference between a pixel block and an adjacent pixel block in each of the different channels based on the average accumulated stress values;
in a case that the accumulated stress difference is less than a preset threshold, merging the pixel block with the adjacent pixel block to obtain a reference pixel block partition, and calculating the average accumulated stress value of the reference pixel block partition; and calculating an accumulated stress value difference between the reference pixel block partition and an adjacent pixel block based on the average accumulated stress values until the accumulated stress value difference is greater than or equal to the preset threshold, to obtain the target pixel block partitions in different channels and the segment accumulated stress values corresponding to the target pixel block partitions.

In an embodiment, after dividing the original image data into blocks to obtain multiple pixel blocks, the method includes:
encoding the pixel blocks according to a preset interlaced encoding rule.

In an embodiment, decompressing the compressed image data based on the partition length and the segment accumulated stress value, to obtain the accumulated stress values of respective pixels in each channel includes:
determining a number of pixel blocks in a target pixel block partition based on the partition length;
decompressing the compressed image data based on the number of the pixel blocks and the segment accumulated stress value, to obtain average accumulated stress values of respective pixel blocks in each channel; and
determining the accumulated stress values of respective pixels in each channel based on the average accumulated stress values of respective pixel blocks in each channel.

In an embodiment, after obtaining average accumulated stress values of respective pixel blocks in each channel, the method includes:
performing linear interpolation in a second direction on the pixel blocks according to the preset interlaced encoding rule.

In a second aspect, the present application provides an image compensation apparatus, including:
an obtaining module, configured to obtain a to-be-processed image, where the to-be-processed image carries accumulated stress values of each pixel in different channels;
a decay determination module, configured to obtain luminance decay degree values of each pixel in different channels based on the accumulated stress values; and
a compensation module, configured to calculate a compensation factor for each pixel based on the luminance decay degree values of each pixel in different channels, and compensate each pixel according to the compensation factor.

In a third aspect, the present application provides a computer device, including a memory and a processor, where the memory stores a computer program, and when executing the computer program, the processor performs the steps of the foregoing method.

In a fourth aspect, the present application provides a non-transitory computer-readable storage medium, storing a computer program, where when the computer program is executed by a processor, the processor is caused to perform the steps of the foregoing method.

In a fifth aspect, the present application provides a computer program product, including a computer program, where when the computer program is executed by a processor, the processor is caused to perform the steps of the foregoing method.

With the foregoing image compensation method and apparatus, the computer device, the computer-readable storage medium, and the computer program product, firstly, the luminance decay degrees of each pixel in different channels are obtained from the accumulated stress values; and then, the compensation factor is dynamically calculated based on the luminance decay degrees of each pixel, so that the compensation factor is adapted to the current decay of each pixel, and the image can be accurately compensated.

### BRIEF DESCRIPTION OF THE DRAWINGS

In order to clearly illustrate technical solutions of embodiments of the disclosure, drawings to be used when describing the embodiments of the disclosure are briefly introduced in the following. It is obvious that the described drawings are only related to some embodiments of the disclosure. Other related drawings can be obtained from these described drawings by the person of ordinary skill in the art without paying inventive efforts.

FIG. 1 is a schematic flowchart of an image compensation method according to an embodiment;

FIG. 2 is a schematic diagram of decay of different channels according to an embodiment;

FIG. 3 is a flowchart of processes of color offset compensation and luminance compensation according to an embodiment;

FIG. 4 is a flowchart of an image data compression process according to an embodiment;

FIG. 5 is another flowchart of an image data compression process according to an embodiment;

FIG. 6 is a structural block diagram of an image compensation apparatus according to an embodiment; and

FIG. 7 is an internal structural diagram of a computer device according to an embodiment.

### DETAILED DESCRIPTION

To make the objectives, technical solutions, and advantages of this application clearer, the following further describes this application in detail according to embodiments in conjunction with the accompanying drawings. It should be understood that specific embodiments described herein are merely used to explain rather than to limit this application.

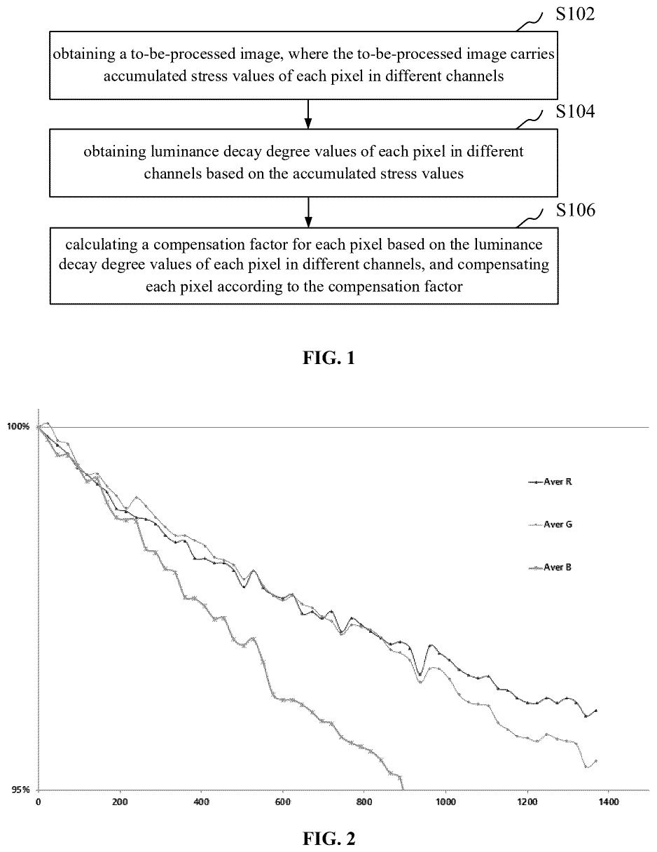

In an embodiment, an image compensation method is provided. In the embodiment, it is exemplarily illustrated that the method is applied to a terminal. It can be understood that the method may alternatively be applied to a server, or may be applied to a system including a terminal and a server and implemented through interaction between the terminal and the server. As shown in FIG. 1, the method includes the following steps S102 to S106.

Step S102 includes: obtaining a to-be-processed image, where the to-be-processed image carries accumulated stress values of each pixel in different channels.

Optionally, if original image data is compressed, the to-be-processed image is decompressed image data; if the original image data is not compressed, the to-be-processed image is the original image data.

The accumulated stress values of each pixel in different channels, carried by the to-be-processed image, are important parameters for quantifying a historical workload of the pixel. The accumulated stress value refers to a total light-emitting amount accumulated when the pixel emits light for a long time on a certain channel, such as an accumulated driving current value, an accumulated power consumption value, or an accumulated lighting time length. The accumulated stress value can reflect the aging degree and luminance decay of the pixel, and serves as a basis for evaluating a current state of the pixel.

Three channels, i.e., R (red), G (green) and B (blue), in an AMOLED display panel have different light-emitting efficiencies and different aging characteristics, for example, an aging speed of the blue channel is often faster while the green channel is more durable. Consequently, each channel needs to independently record and carry its corresponding accumulated stress value. For example, reference can be made to FIG. 2, which is a schematic diagram of decay of different channels according to an embodiment.

Step S104 includes: obtaining luminance decay degree values of each pixel in different channels based on the accumulated stress values.

Optionally, a relationship between the accumulated stress value and the luminance decay degree may be fitted by an empirical model or an experimentally measured function. For example, a common model is a Stretched Exponential Decay (SED) model:

$$L ( t ) = L 0 \cdot {e}^{- {( \frac{t}{τ} )}^{β}} \qquad formula ( 1 )$$

Here, L(t) represents a current luminance; L₀ represents an initial luminance; t represents the accumulated stress value; τ represents a time constant of a material, for indicating an aging speed; and β is a nonlinear parameter related to the aging degradation characteristic of the material. The luminance decay degree of the pixel on each channel can be calculated by using the formula (1).

In other embodiments, the luminance decay degree of the pixel on each channel may alternatively be calculated through a polynomial fitting model, a machine learning model and the like.

Step S106 includes: calculating a compensation factor for each pixel based on the luminance decay degree values of each pixel in different channels, and compensating each pixel according to the compensation factor.

In the embodiment, the compensation factor corresponding to each pixel is calculated based on the luminance decay degree values of each pixel in different channels, to provide a basis for luminance compensation of each pixel. In this way, the compensation factor can be generated targetedly in light of the actual luminance loss of each pixel, thereby achieving more accurate compensation.

Optionally, the compensation factor may be calculated through a ratio of a target luminance proportion to a current luminance decay degree, for example, the compensation factor may be expressed as the target luminance proportion divided by a current luminance decay proportion.

Optionally, the compensation factor may alternatively be obtained by calculating a difference between luminance decay degree values of different channels. In some cases, not only the luminance decay degree value of each channel needs to be independently compensated, but also a decay difference between the channels needs to be comprehensively considered; especially when the decay difference is excessively large, a problem of obvious color offset may be caused. In this case, a difference value between channels may be calculated based on luminance decay degree values of different channels, to determine an additional compensation factor, and the additional compensation factor is configured to perform higher luminance compensation on a channel with higher decay. It may be referred to descriptions in embodiments hereinafter.

Exemplarily, after the compensation factor is obtained, a compensation operation is achieved by scaling up or scaling down a luminance value based on a current luminance value of the pixel and the calculated compensation factor, as shown in formula (2):

$${Gray}_{1} = {Gray}_{0} * ( 1 + compensation factor ) \qquad formula ( 2 )$$

where Gray₁ represents a luminance value after compensation, and Gray₀ represents a luminance value before compensation.

In the above image compensation method, firstly, the luminance decay degrees of each pixel in different channels are obtained from the accumulated stress values; and then, the compensation factor is dynamically calculated based on the luminance decay degrees of each pixel, so that the compensation factor is adapted to the current decay of each pixel, and the image can be accurately compensated.

Further, in order to reduce the calculation amount of the step of calculating the luminance decay degree values of each pixel in different channels based on the accumulated stress values, in an exemplary embodiment, obtaining the luminance decay degree values of each pixel in different channels based on the accumulated stress values includes: obtaining preset lookup tables corresponding to different channels, where each preset lookup table is generated based on a relationship between historical accumulated stress values and current luminance decay degrees; and separately querying, based on the accumulated stress values, the preset lookup tables corresponding to different channels, to obtain the luminance decay degree values of each pixel in different channels.

First, the preset lookup tables respectively corresponding to different channels are obtained, that is, R, G and B channels each correspond to one preset lookup table. Each preset lookup table is generated based on experiments or simulations, and represents a relationship between the historical accumulated stress values and the current luminance decay degree values. The generation process of the preset lookup table may be completed by long-term display test data fitting, reflecting a nonlinear relationship between the accumulated stress values and the luminance decay degrees. For example, the lookup table may record luminance decay degree values under different accumulated stress values.

In the compensation process, the preset lookup tables corresponding to different channels are respectively queried based on the accumulated stress values to quickly obtain the luminance decay degree values of each pixel. Specifically, the accumulated stress values of each pixel are matched through the preset lookup tables, to find the corresponding luminance decay degree values. A direct correspondence between the accumulated stress values and the luminance decay degree values has been established in advance in each preset lookup table, so it only requires a simple query operation to obtain a result, thereby avoiding complex real-time calculation. This approach is particularly suitable for large-scale pixel processing scenarios, and greatly improves the real-time performance and efficiency of the system.

With this approach, the luminance decay degree values can be quickly obtained and high accuracy can be ensured at the same time. Compared with a traditional approach of real-time calculation, the approach based on the preset lookup tables significantly reduces the calculation amount and hardware resource consumption.

Further, in an exemplary embodiment, the step of calculating the compensation factor for each pixel based on the luminance decay degree values of each pixel in different channels, and compensating each pixel according to the compensation factor includes: determining a display status of each pixel based on the luminance decay degree values of each pixel in different channels; in a case that the display status is that there is a color offset, calculating a decay difference of each pixel in different channels, using the decay difference as the compensation factor, and compensating each pixel according to the compensation factor; and in a case that the display status is that there is a luminance decay, obtaining a target luminance value, using the target luminance value as the compensation factor, and performing luminance compensation on each pixel according to the compensation factor.

First, the display status of each pixel is determined; and then, different compensation factors are calculated according to different display statuses, and compensation can be performed according to the different compensation factors.

In the embodiment, there are two types of display statuses: color offset and luminance decay. The color offset refers to that the luminance decay degrees of different channels differ from each other greatly, resulting in imbalance in color ratio, so that a color offset phenomenon occurs in a display image. For example, in a case that the decay degree of the blue channel is much higher than those of the red and green channels, the display image may present abnormally in a tone of red-and-green. This status usually occurs when the usage load of a certain channel is significantly higher than that of other channels, such as when the screen displays content with high blue light intensity for a long time. The luminance decay means that the luminance of each channel is decayed to a large extent, but decay degrees of different channels are relatively close, and no obvious color imbalance is caused. Under this status, the entire display image is darkened while the color ratio still remains substantially consistent. For example, when the luminance decay of the three channels R, G, and B is 10%, 12%, and 11%, respectively, no significant color offset is caused although the luminance of the display image as a whole is decreased.

Different compensation strategies may be adopted for different display statuses. The channel with larger decay is compensated, so that the luminance of the channel is restored to a level consistent with those of other channels, thereby correcting the color offset. For the luminance decay status, it is necessary to uniformly compensate all channels, to restore the overall luminance to a target level and at the same time prolong the service life of the display panel as much as possible. In this way, luminance compensation can possess better pertinence and higher effectiveness.

In the case that the display status is that there exists the color offset, a decay difference of each pixel in different channels is calculated, the decay difference is used as the compensation factor, and color offset compensation is performed on the pixel according to the compensation factor. Under the color offset status, the main problem of the image is that the luminance of the channels is uneven, so it is necessary to dynamically adjust the compensation factor based on the decay difference of different channels, so that the channel with larger decay is subjected to higher compensation, thereby reducing the difference among the channels.

In the case that the display status is that there exists the luminance decay, a target luminance value is obtained and serves as the compensation factor, and luminance compensation is performed on each pixel according to the compensation factor. Under the luminance decay status, the main problem of display is overall luminance decrease, so the objective of compensation is to compensate for the luminance of respective channels. The overall luminance level can be effectively restored by compensating all channels with a uniform target luminance value.

Further, the processes of calculating the decay difference of each pixel in different channels, using the decay difference as the compensation factor, and compensating each pixel according to the compensation factor include: determining a maximum decay channel and a minimum decay channel based on luminance decay degree values of each pixel in different channels; calculating the decay difference based on the maximum decay channel and the minimum decay channel; and compensating a luminance value corresponding to the maximum decay channel based on the decay difference, to cause the luminance decay degree value of the maximum decay channel to be consistent with the luminance decay degree value of the minimum decay channel.

In the case that the display status is that there exists the color offset, the maximum decay channel and the minimum decay channel are first determined from the luminance decay degree values of each pixel in different channels. The maximum decay channel and the minimum decay channel respectively represent channels with maximum and minimum luminance decay degree values.

For example, if luminance decay degree values of a pixel in different channels are indicated by 1−(0.91,0.95,0.88)=(0.09,0.05,0.12), then, the maximum decay channel is the B channel and the luminance decay degree value of the B channel is the largest, and the minimum decay channel is the G channel and the luminance decay degree value of the G channel is the smallest.

After the maximum luminance decay channel and the minimum luminance decay channel are determined, the decay difference is calculated based on the luminance decay degree values corresponding to the maximum luminance decay channel and the minimum luminance decay channel; the decay difference is used as the compensation factor; and the luminance value corresponding to the maximum decay channel is compensated according to the compensation factor, to cause the luminance decay degree value of the maximum decay channel to be consistent with the luminance decay degree value of the minimum decay channel.

For example, assuming that the blue channel is decayed by 0.04, the red channel is decayed by 0.03, and the green channel is decayed by 0.02. In this case, the maximum decay channel is the blue channel and the minimum decay channel is the green channel. The blue channel needs to be compensated to be consistent with the green channel. The compensation factor equals 0.04-0.02, and the process of compensating according to the compensation factor can be expressed by: Gray*(1+(0.04−0.02)).

Further, the processes using the target luminance value as the compensation factor and performing luminance compensation on each pixel according to the compensation factor include: compensating luminance values of each pixel in different channels based on the target luminance value.

In the case that the display status is that there exists the luminance decay, luminance compensation needs to be performed on each channel of each pixel. In the compensation process, compensation is performed based on the target luminance value.

The target luminance value is set in advance. The target luminance value may be set to 0.02. A specific reason for this setting can refer to descriptions in a following embodiment.

For example, a process of compensating for luminance of different channels can be expressed by: Gray*((1−0.02)+current luminance decay degree value).

Further, in an exemplary embodiment, the display status may be determined as follows: in a case that a maximum luminance decay degree value is less than a preset threshold and a difference between the maximum luminance decay degree value and a minimum luminance decay degree value is greater than a difference threshold, or in a case that the maximum luminance decay degree value is greater than the preset threshold and the minimum luminance decay degree value is less than the preset threshold, determining that the display status is that there exists the color offset; and in a case that both the maximum luminance decay degree value and the minimum luminance decay degree value are greater than or equal to the preset threshold, determining that the display status is that there exists the luminance decay.

The preset threshold and the difference threshold are set in advance. The preset threshold may be set to 0.05, and the difference threshold may be set to 0.015.

In the embodiment, the maximum luminance decay degree value is represented by max (αr, αg, αb), and the minimum luminance decay degree value is represented by min (αr, αg, αb).

In a first case, max (αr, αg, αb)<0.05 and max (αr, αg, αb)−min (αr, αg, αb)>0.015, which indicates that decay degrees of all sub-pixels are relatively low, and none of the sub-pixels has reached a relatively high decay level. However, there is a relatively large decay difference, and the decay difference exceeds the threshold of 0.015, which results in color offset.

In a second case, max (αr, αg, αb)>0.05 and min (αr, αg, αb)<0.05, which indicates that at least one sub-pixel has a relatively high decay degree, and another sub-pixel has a relatively low decay degree, which may also cause color offset.

In the foregoing two cases, the sub-pixel with a maximum decay degree is to be adjusted to be consistent with the sub-pixel with a minimum decay degree. This adjustment is to eliminate the color offset and ensure that the decay degrees of sub-pixels of respective colors are close, thereby maintaining the balance and accuracy of color.

In a third case, max (αr, αg, αb)>=0.05 and min (αr, αg, αb)>=0.05, which indicates that decay degrees of all sub-pixels are relatively high, and decay differences between the sub-pixels are not significant. In this case, the luminance of the entire display screen may have decreased, and overall luminance compensation needs to be performed.

It should be noted that reasons for setting the preset threshold, the difference threshold, and the target luminance value to 0.05,0.015 and 0.02 respectively are as follows.

The preset threshold is set to 0.05, which means that when the luminance decay degree reaches or exceeds 5%, it is determined whether compensation is required. When the luminance decay of the pixel is relatively light, for example, the decay is less than 5%, this luminance variation is usually difficult to be perceived by human eyes, and the display effect may not be significantly affected, so there is no need to perform immediate compensation. Setting the preset threshold to 0.05 can avoid premature triggering of compensation, reduce unnecessary compensation operations, and save computing resources and hardware power consumption.

The difference threshold is set to 0.015, which means that existence of color offset is determined only when a difference of luminance decay degrees of respective channels exceeds 0.015. Human eyes have a certain tolerance range for color perception, and only when the luminance decay difference of different channels reaches a certain degree, such as 0.015, an obvious color offset can be perceived.

The target luminance value is set to 0.02, indicating that the luminance is compensated to a state in which the decay degree is 2%, that is, the compensated luminance is 98% of the initial luminance. If the luminance is directly compensated to 100%, that is, the luminance is completely restored to the initial luminance, the pixel needs to withstand a relatively high drive current or power output, which may accelerate aging of the pixel and affect the service life of the display screen. Setting the target luminance value to 0.02, that is, compensating to 98%, is a compromised result of taking both luminance restoration and pixel lifetime into consideration, which can moderately reduce the pixel burden and delay aging of the pixel. Compensation to 98% is sufficient for the human eyes to perceive luminance restoration without affecting the overall uniformity of the image. Too much compensation, for example, to 100% or insufficient compensation may lead to luminance non-uniformity, adversely affecting user experience; hence, compensation to 98% is considered as a relatively ideal target luminance.

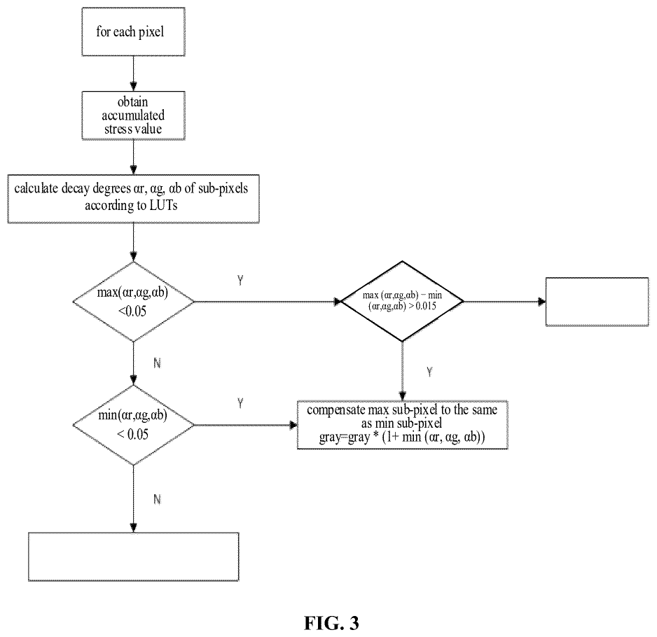

In an exemplary embodiment, as shown in FIG. 3, FIG. 3 is a flowchart of processes of color offset compensation and luminance compensation.

The pseudo-code of the compensation processes is as follows:

```
If max(αr,αg,αb)<0.05;
    If max(αr,αg,αb)−min(αr,αg,αb)>0.015,
      the sub-pixel corresponding to max is compensated to be consistent
      with min
  Else max(αr,αg,αb)>0.05,
    If min(αr,αg,αb)<0.05,
      the sub-pixel corresponding to max is compensated to be consistent
      with min
    else
```

each sub-pixel is compensated to a decay degree of 0.02

When max (αr, αg, αb)<0.05 is satisfied, it is further determined whether max (αr, αg, αb)−min (αr, αg, αb)>0.015 is satisfied, if yes, it indicates that there is a color offset, and the color offset compensation is performed; otherwise, it indicates that the decay of respective channels is basically uniform and the display image does not have an obvious color offset, so there is no need to perform other operations. When max (αr, αg, αb)>0.05 is satisfied, it is further determined whether min (αr, αg, αb)<0.05 is satisfied, if yes, it indicates that there is a color offset, otherwise, luminance compensation is performed.

Further, in an exemplary embodiment, an image data decompression manner is provided, in which compressed image data is decompressed to obtain to-be-processed image data. Original image data usually includes a large amount of pixel information, and each pixel may need to store luminance values or accumulated stress values of three channels R, G, and B. Without compression, the overall data volume is very large, especially for high-resolution display screens, such as 4K or 8K resolution, and the required storage space increases exponentially.

For example, it is assumed that a resolution of a display screen is 2560×1600, each pixel needs to store 3 channels×32 bits, so required storage space (per frame) without compression is 2560×1600×3×32 bits≈49.15 MB. The large amount of original image data may occupy too much transmission bandwidth and increase the burden of decoding and calculation, thereby affecting the processing speed. Therefore, in the present application, the original image data is compressed.

For ease of understanding compression and decompression processes, in this application, compressing the original image data into compressed image data is first described, and then decompressing the compressed image data into the original image data is described.

Optionally, in an exemplary embodiment, the compression process to obtain the compressed image data includes: obtaining original image data; dividing the original image data into blocks to obtain multiple pixel blocks; calculating average accumulated stress values of each pixel block in different channels based on accumulated stress values of respective pixels in each pixel block in different channels; merging the pixel blocks in different channels based on the average accumulated stress values of each pixel block in different channels to obtain target pixel block partitions in different channels and segment accumulated stress values corresponding to the target pixel block partitions; and performing compression based on numbers of pixel blocks corresponding to the target pixel block partitions in different channels and the segment accumulated stress values corresponding to the target pixel block partitions in different channels, to obtain the compressed image data.

Optionally, the original image data may be divided into blocks according to a preset dividing rule. For example, the preset dividing rule may be that every 4×4 pixels or every 2×2 pixels are divided into one pixel block. In this way, the pixel data can be divided into smaller processing units, so the system can manage and process image information more efficiently.

In an embodiment, the original image data is divided into blocks by unit of 2×2 to obtain multiple pixel blocks. Here, using the dividing rule in unit of 2×2, local change characteristics can be accurately captured, thereby ensuring accurate compensation. For example, assuming that the original image data occupies 4×4 pixels, four pixel blocks each including 2×2 pixels can be obtained by dividing the original image data by unit of 2×2.

Then, the average accumulated stress values corresponding to each pixel block in different channels are calculated based on the accumulated stress values corresponding to respective pixel points in each pixel block in different channels. For example, it is assumed that one pixel block includes 2×2 pixels, and each pixel has a corresponding accumulated stress value on each of the three channels R, G, and B. The system may sum up the accumulated stress values of all pixels in the pixel block in the R channel, and divide the sum by a total number of the pixels, to obtain the average accumulated stress value in the R channel. The average accumulated stress values in the G and B channels can be calculated in the same way.

After the average accumulated stress values corresponding to each pixel block in different channels are obtained, merging is performed based on the average accumulated stress values to obtain the target pixel block partitions in different channels. The target pixel block partition includes multiple similar pixel blocks. The pixel blocks are merged, and a representative target pixel block partition is utilized to represent the entire region, thereby greatly reducing the occupation of the storage space. In addition, the target pixel block partition may be utilized to uniformly calculate the accumulated stress value and a luminance compensation parameter, thereby avoiding repeated operations for respective pixel blocks and improving compensation efficiency.

Each pixel block has different average accumulated stress values in different channels; accordingly, final merging results in respective channels are also different. For example, on the R channel, three pixel blocks may be merged into one target pixel block partition; on the G channel, two pixel blocks may be merged into one target pixel block partition; and on the B channel, one pixel block serves as one target pixel block partition. This is caused by distribution difference of the accumulated stress values of the same pixel block in different channels.

In this way, the target pixel block partitions in different channels and the segment accumulated stress values corresponding to the target pixel block partitions can be obtained.

The segment accumulated stress value is obtained based on the average accumulated stress values corresponding to respective pixel blocks in the target pixel block partition. For example, if the target pixel block partition includes three pixel blocks, and the average accumulated stress values of the three pixel blocks in the R channel are 121,134,156, the segment accumulated stress value is a mean value of the average accumulated stress values, that is, (121+134+156)/3=137.

In other embodiments, the segment accumulated stress value may be obtained by summing up, weighted averaging or performing other operations on the average accumulated stress values corresponding to respective pixel blocks in the target pixel block partition, which is not limited herein.

Finally, the target pixel block partitions in different channels and the segment accumulated stress values corresponding to the target pixel block partitions in different channels can be obtained. And then, compression can be performed based on the number of pixel blocks included in the target pixel block partition and the segment accumulated stress value, to obtain a target compressed image.

For example, assuming that in the R channel, the target pixel block partition includes three pixel blocks, and the segment accumulated stress value corresponding to the target pixel block partition is 137, the original image may be compressed into a form of (3,137) in the R channel. Compression in other channels are similar, and details are not repeated herein.

In this way, the original image can be compressed, in different channels, into a form of (BN, V), where BN represents the number of pixel blocks, and V represents the segment accumulated stress value.

Further, in an embodiment, the process of merging the pixel blocks in different channels based on the average accumulated stress values of respective pixel blocks in different channels to obtain the target pixel block partitions in different channels and the segment accumulated stress values corresponding to the target pixel block partitions includes: in a first direction, calculating an accumulated stress value difference between a pixel block and an adjacent pixel block in each of the different channels based on the average accumulated stress values; if the accumulated stress value difference is less than a preset threshold, merging the pixel block with the adjacent pixel block to obtain a reference pixel block partition, and calculating the average accumulated stress value of the reference pixel block partition; and calculating an accumulated stress value difference between the reference pixel block partition and an adjacent pixel block based on the average accumulated stress values until the accumulated stress value difference is greater than or equal to the preset threshold; in this way, the target pixel block partitions in different channels and the segment accumulated stress values corresponding to the target pixel block partitions can be obtained. In the present application, the accumulated stress value difference between one block/block partition and another block/block partition refers to an absolute value of a difference between the average accumulated stress value of one block/block partition and the average accumulated stress value of another block/block partition.

The first direction is a horizontal direction, and the accumulated stress value difference refers to a difference between the average accumulated stress values of two pixel blocks adjacent in the horizontal direction.

In the merging process, an accumulated stress value difference between two adjacent pixel block partitions in the horizontal direction is obtained, and if the accumulated stress value difference is less than a preset threshold, it is determined that the two pixel block partitions have relatively similar accumulated stress characteristics, and may be located in regions with similar luminance decay degrees. The two adjacent pixel block partitions are merged to obtain a reference pixel block partition, and an average accumulated stress value corresponding to the reference pixel block partition is calculated based on average accumulated stress values corresponding to the two pixel block partitions. Then, an accumulated stress value difference between the reference pixel block partition and an adjacent pixel block partition is further obtained, and if the accumulated stress value difference is less than the preset threshold, merging is continued; and when the accumulated stress value difference is greater than or equal to the preset threshold, merging is stopped, and the target pixel block partition and the segment accumulated stress value corresponding to the target pixel block partition are obtained.

Taking the R channel as an example, there are the following pixel blocks: block 00, block 01, block 02, block 03, block 04, block 10, block 11, block 12, block 13, and block 14.

Comparing block 00 with block 01, if block 00 and block 01 meet a merging condition, that is, the accumulated stress value difference between block 00 and block 01 is less than the preset threshold, block 00 and block 01 are merged, and a mean value of the average accumulated stress values of block 00 and block 01 is calculated as the average accumulated stress value of the reference pixel block partition. Then, the accumulated stress value difference between block 02 and the reference pixel block partition is obtained, and if the merging condition is met, block 02 and the reference pixel block partition are merged, and the average accumulated stress value is updated. The above operations are further performed for subsequent blocks in the horizontal direction until the merging condition is not satisfied.

Processes for other pixel channels are similar to the R channel, and are not specifically described in the embodiment.

Further, since most images have highly related contents in adjacent regions, and data of some segments can be deleted, in an embodiment, pixel blocks are encoded in a preset interlaced encoding manner, thereby further compressing the original image data.

The preset interlaced encoding manner is a method for regularly sampling and storing image data line by line, to reduce a data storage amount and improve transmission or processing efficiency. It may only save the image data at an interval of every preset number of lines, and reconstruct the missing line data by an interpolation algorithm when needed.

For example, the original image data is divided into the following data blocks:
line 0: block 00, block 01, block 02, block 03, block 04, block 05
line 1: block 10, block 11, block 12, block 13, block 14, block 15
line 2: block 20, block 21, block 22, block 23, block 24, block 25
line 3: block 30, block 31, block 32, block 33, block 34, block 35.

If the preset interlaced coding is to store data of odd lines, data of line 1 and line 3 are stored; and if the preset interlaced coding is to store data of even lines, data of line 0 and line 2 are stored.

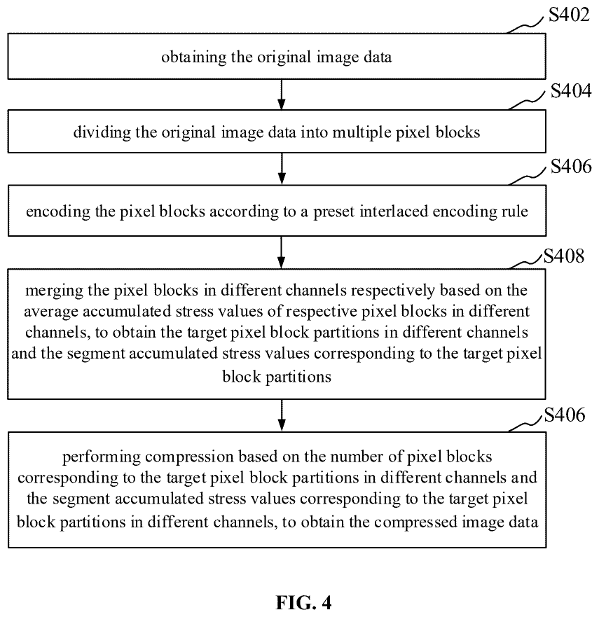

In summary, with reference to FIG. 4, an image data compression process includes:
step S402: obtaining the original image data;
step S404: dividing the original image data into multiple pixel blocks;
step S406: encoding the pixel blocks according to a preset interlaced encoding rule;
step S408: merging the pixel blocks in different channels respectively based on the average accumulated stress values of respective pixel blocks in different channels, to obtain the target pixel block partitions in different channels and the segment accumulated stress values corresponding to the target pixel block partitions; and
step S410: performing compression based on the number of pixel blocks corresponding to the target pixel block partitions in different channels and the segment accumulated stress values corresponding to the target pixel block partitions in different channels, to obtain the compressed image data.

In this way, each line of the original image data in each of the different channels may be compressed into a form of (BN, V).

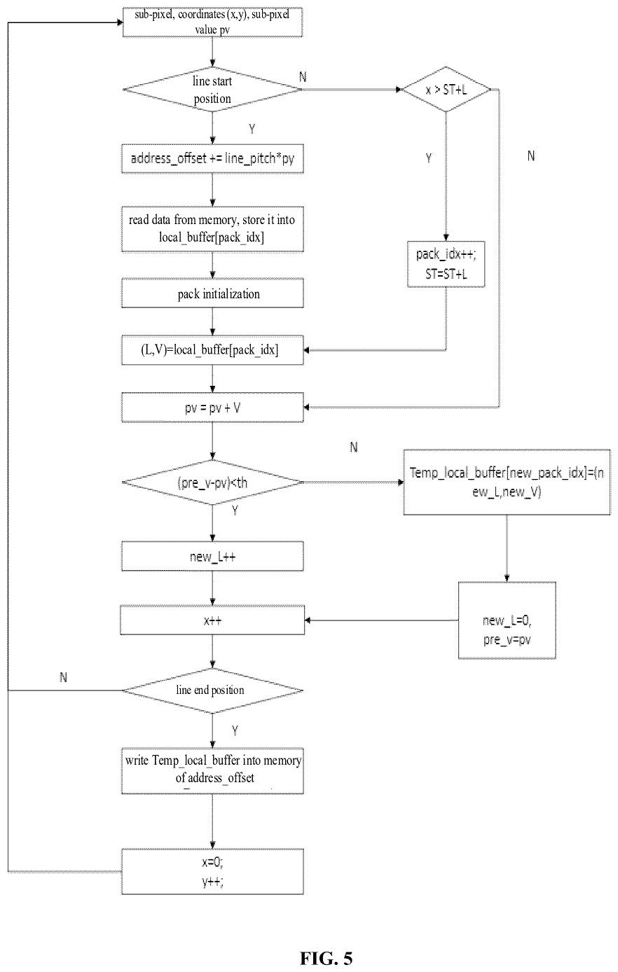

Reference may be made to FIG. 5, which is a flowchart of image data compression according to an exemplary embodiment.
1) Initialization of packs. Taking R sub-pixels as an example, new_v=0, new_1=0; new_pack_idx=0, where v represents an average value of a partition, 1 represents the number of blocks in unit of 2×2, and pack_idx represents an index value of a current partition.
2) Reading one line of data from the memory according to the address, packs in one line may be set with a maximum number, such as 256 packs per line; parsing pack data, and sequentially storing the BN and the accumulated value V, according to (4 bit+32 bit)×3 (R+G+B), into local_buffer[c_num][pack_num][v_num]. For example, 256 target pixel block partitions are fixedly allocated in each line, and information about each target pixel block partition includes: the number of 2×2 blocks, i.e., the BN (4 bit), and the accumulated value V (32 bit). Hence, a total of 36*256 bits are required, among which 4×256 bits are utilized to store BN and 32×256 bits are used to store V, and the information is sequentially stored target pixel block partition by target pixel block partition.
3) Taking the R channel as an example, the pseudo code is as follows:

```
  if line_start, //determine whether it is a line start position, i,e, a first pixel of a line
    address = address+line_pitch*py //according to the line coordinate, calculate
the historical accumulated data storage address of the line
    initial pack //read the historical accumulated information corresponding to the
line from the above address, and store the historical accumulated information into the
local_buffer, where the accumulated information is stored according to segments, for example,
256 segments of information
  L = local_buffer[0][pack_idx][0]
  V = local_buffer[0][pack_idx][1]
  if (px > ST+L) pack_idx++; ST+= L; //the pixel belongs to a next historical segment
(a current pixel index px exceeds an end position ST+L of a current segment)
  pv = pv+V
  if abs (pre_pv − pv) <th new_L++; pre_pv = sum/new_L; //pre_pv = sum/new_L; //if
an absolute value of a difference between a new accumulated value of a current pixel and an
average of new accumulated values of pixels in a previous non-merge region < a set threshold,
the current pixel can be merged; the average value of the merged region is calculated
  else
    Temp_local_buffer[0][new_pack_idx][0] = new_L; //record the accumulated
value of a new segment, those after the current frame are accumulated
    Temp_local_buffer[0][new_pack_idx][1] = pv; //record the accumulated value
of a new segment, those after the current frame are accumulated
    new_pack_idx+; //next segment index
    pre_pv = pv; //scan for one line is completed, new segment information is
written into the memory
  if line_end,
```

write Temp_local_buffer data to memory at address, cover history data

In the embodiment, in a case that a merging condition is met, that is, the difference is less than the preset threshold th, it indicates that the pixel has a similar feature to the previous pixel and is suitable for merging, so the length of a current line segment is increased, that is, new_L++. In a case that the merging condition is not satisfied, that is, the difference is not less than the threshold th, it indicates that a feature difference between the current pixel and the previous pixel is large and the current pixel is not suitable for merging. In this case, the current line segment is ended and information of the current line segment is recorded, and a new line segment is started.

Correspondingly, a corresponding decompression manner includes: decompressing the compressed image data based on a partition length and a segment accumulated stress value, to obtain accumulated stress values of respective pixels in each channel, which includes: determining a number of pixel blocks in a target pixel block partition based on the partition length; decompressing the compressed image data based on the number of the pixel blocks and the segment accumulated stress value, to obtain average accumulated stress values of respective pixel blocks in each channel; and determining the accumulated stress values of respective pixels in each channel based on the average accumulated stress values of respective pixel blocks in each channel.

First, the number of pixel blocks in the target pixel block partition may be determined based on the partition length, that is, the BN. Then, the average accumulated stress values corresponding to respective pixel blocks may be generated based on the segment accumulated stress value, and the accumulated stress values corresponding to respective pixels are generated based on the average accumulated stress values corresponding to respective pixel blocks.

Taking the R channel as an example, assuming that a certain line of data is compressed into the form of (2,10), it can be determined that the line of data includes two pixel blocks, and the average accumulated stress value corresponding to each pixel block is 10; that is, the average accumulated stress value corresponding to pixel block 1 is 10, and the average accumulated stress value corresponding to pixel block 2 is 10. The average accumulated stress value corresponding to each pixel block is obtained by calculating the average of the accumulated stress values corresponding to respective pixels in the pixel block; therefore, the average accumulated stress value corresponding to the pixel block is the accumulated stress value corresponding to each pixel in the pixel block. Similarly, the same decompression is also performed in other pixel channels.

Further, after the pixel blocks are obtained, since the pixel blocks are encoded in the preset interlaced encoding manner, corresponding decoding needs to be performed during decompression.

Therefore, in an exemplary embodiment, after the average accumulated stress values corresponding to respective pixel blocks in each channel are obtained, linear interpolation is performed in a second direction on the pixel blocks according to the preset interlaced encoding rule.

In the embodiment, linear interpolation is performed in the second direction on respective pixel blocks according to the preset interlaced encoding rule to obtain the pixel blocks before encoding. The second direction is a vertical direction.

Continuing with the above exemplary embodiment, data blocks after encoding include:
line 0: block 00, block 01, block 02, block 03, block 04, block 05
line 2: block 20, block 21, block 22, block 23, block 24, block 25

Then, linear interpolation is performed based on values of an upper line and a lower line, which actually means an average of the values of the upper line and the lower line is interpolated therebetween. For example, block 10 between block 00 and block 10 is obtained by calculating the average of the values of block 00 and block 20.

In an exemplary embodiment, an image compensation approach is provided.

In a compensation process for aging of an OLED panel, a display device needs to continuously record an accumulated stress value of each pixel. This historical data is of a large amount, and the amount continuously grows over time. If original data is stored directly, the storage space of the device may be quickly exhausted. Therefore, the original image data needs to be compressed, and the original image data is compressed into (BN, V). Details of a compression process may be understood with reference to descriptions on the process of compressing the original image according to foregoing embodiments, and the details are not given in the embodiment.

For example, the number of data blocks is BN, restriction for storage in each line is 256, and the accumulated value occupies 32 bits. A total storage space as required amounts to: 4.5 B (4+32)*256*1600*3/2=2764800 Byte=2.7648 MB. Moreover, since most images have highly related contents in adjacent regions, data of some segments may be deleted, and interlaced encoding is proposed. For example, data of an i-th line and data of an (i+2)-th line are stored, and then data of an (i+1)-th line is obtained by performing interpolation on the data of the i-th line and the data of the (i+2)-th line. The compression ratio is further increased due to the interlaced encoding.

Therefore, when compensating the image, compressed image data is obtained first, and image data to be processed can be obtained by decoding and decompressing the compressed image data, that is, accumulated stress values of each pixel in different channels can be obtained.

After the accumulated stress values of each pixel in different channels are obtained, luminance decay degrees of each pixel in different channels are determined by querying preset lookup tables. Each channel corresponds to one preset lookup table, and the lookup tables for different channels are independent from each other.

Then, a compensation factor corresponding to each pixel is determined based on the luminance decay degrees of each pixel in different channels, and each pixel is compensated according to the compensation factor. Details of the compensation process may be understood with reference to descriptions on compensation to the pixels according to foregoing embodiments.

In the embodiment, the original image data is compressed. For one thing, data to be stored is reduced, so the storage resources are saved, thereby reducing the area occupied by the chip; for another, the adaptive partition length plays a role of retaining the data details to a certain extent. Furthermore, the color offset caused by the inconsistency of the decay degrees of each pixel in different channels is compensated, so the display effect is further improved, and the visual experience is improved. In addition, in the compensation process, the compensation factor can be adaptively selected, which not only controls the aggravation of sub-pixel aging, but also slows down the further enlargement of sub-pixel decay difference.

It should be understood that although the steps in the flowcharts involved in the above embodiments are sequentially displayed as indicated by the arrows, these steps are not necessarily performed in the order indicated by the arrows. Unless explicitly stated herein, the execution of these steps is not strictly limited, and these steps may be executed in other orders. Moreover, at least part of the steps in the flowcharts involved in the above embodiments may include multiple sub-steps or multiple stages, these sub-steps or stages are not necessarily performed at the same time, but may be performed at different moments; and the execution order of these sub-steps or stages is not necessarily performed sequentially, but may be performed in turn or alternately with at least part of other steps or the sub-steps or stages in other steps.

Based on the same inventive concept, an image compensation apparatus is further provided according to an embodiment of the present application, for implementing the foregoing image compensation method. The implementation solution for solving the problem provided by the apparatus is similar to the implementation solution described in the above method, so specific limitations in one or more embodiments directed to the image compensation apparatus provided below may refer to foregoing limitations to the image compensation method, and are not repeated here.

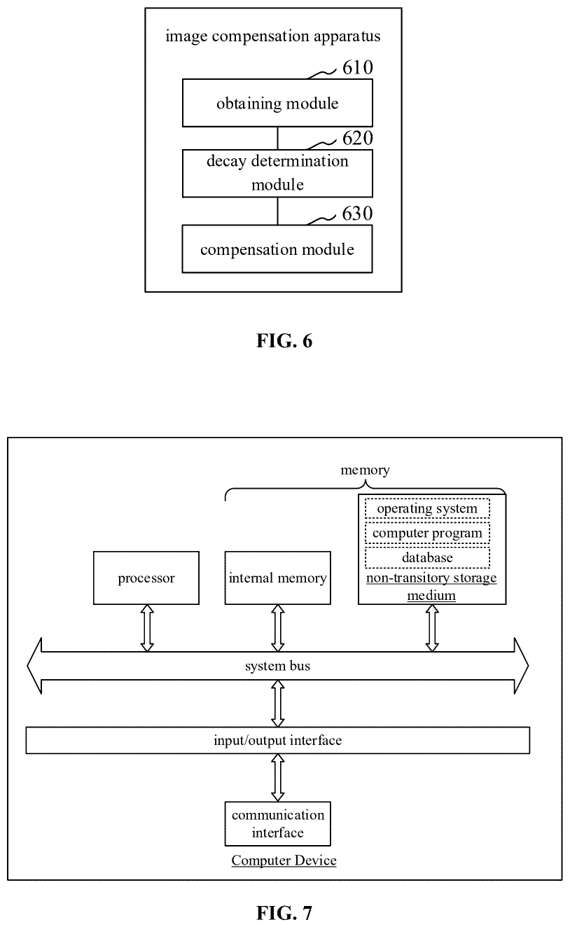

In an exemplary embodiment, an image compensation apparatus is provided. As shown in FIG. 6, the image compensation apparatus includes: an obtaining module 610, a decay determination module 620, and a compensation module 630.

The obtaining module 610 is configured to obtain a to-be-processed image, where the to-be-processed image carries accumulated stress values of each pixel in different channels.

The decay determination module 620 is configured to obtain luminance decay degree values of each pixel in different channels based on the accumulated stress values.

The compensation module 630 is configured to: calculate a compensation factor for each pixel based on the luminance decay degree values of each pixel in different channels, and compensate each pixel according to the compensation factor.

In an embodiment, the decay determination module 620 includes:
a lookup table obtaining unit, configured to obtain preset lookup tables corresponding to different channels, where each preset lookup table is generated based on a relationship between historical accumulated stress values and current luminance decay degrees; and
a lookup unit, configured to separately query, based on the accumulated stress values, the preset lookup tables corresponding to different channels, to obtain the luminance decay degree values of each pixel in different channels.

In an embodiment, the compensation module 630 includes:
a display calculation unit, configured to determine a display status of each pixel based on the luminance decay degree values of each pixel in different channels;
a color offset compensation unit, configured to: in a case that the display status is that there is a color offset, calculate a decay difference of each pixel in different channels, use the decay difference as the compensation factor, and perform color offset compensation on each pixel according to the compensation factor; and
a luminance compensation unit, configured to: in a case that the display status is that there is a luminance decay, obtain a target luminance value, use the target luminance value as the compensation factor, and perform luminance compensation on each pixel according to the compensation factor.

In an embodiment, the color offset compensation unit includes:
a channel determination subunit, configured to determine a maximum decay channel and a minimum decay channel based on the luminance decay degree values of each pixel in different channels;
a difference calculation subunit, configured to calculate the decay difference based on the maximum decay channel and the minimum decay channel; and
a first compensation subunit, configured to compensate a luminance value corresponding to the maximum decay channel based on the decay difference, to cause the luminance decay degree value of the maximum decay channel to be consistent with the luminance decay degree value of the minimum decay channel.

In an embodiment, the luminance compensation unit includes:
a second compensation subunit, configured to compensate luminance values of each pixel in different channels based on the target luminance value.

In an embodiment, the compensation module 630 further includes a determination unit, and the determination unit includes:
a first determination subunit, configured to: in a case that a maximum luminance decay degree value is less than a preset threshold and a difference between the maximum luminance decay degree value and a minimum luminance decay degree value is greater than a difference threshold, or in a case that the maximum luminance decay degree value is greater than the preset threshold and the minimum luminance decay degree value is less than the preset threshold, determine that the display status is that there exists the color offset; and
a second determination subunit, configured to: in a case that both the maximum luminance decay degree value and the minimum luminance decay degree value are greater than or equal to the preset threshold, determine that the display status is that there exists the luminance decay.

In an embodiment, the to-be-processed image is obtained by decompressing compressed image data, where the compressed image data includes a partition length and a segment accumulated stress value that correspond to a target pixel block partition in each channel, and the image compensation apparatus further includes:
a decompression module, configured to decompress the compressed image data based on the partition length and the segment accumulated stress value, to obtain accumulated stress values of respective pixels in each channel.

In an embodiment, the image compensation apparatus further includes a compression module, and the compression module includes:
an original image obtaining unit, configured to obtain original image data;
a dividing unit, configured to divide the original image data into blocks to obtain multiple pixel blocks;
an average value calculation unit, configured to calculate average accumulated stress values of each pixel block in different channels based on accumulated stress values of respective pixels in each pixel block in different channels;
a block merging unit, configured to merge the pixel blocks in different channels based on the average accumulated stress values of each pixel block in different channels, to obtain target pixel block partitions in different channels and segment accumulated stress values corresponding to the target pixel block partitions; and
a data compression unit, configured to perform compression based on numbers of pixel blocks corresponding to the target pixel block partitions in different channels and the segment accumulated stress values corresponding to the target pixel block partitions in different channels, to obtain the compressed image data.

In an embodiment, the block merging unit includes:
a difference calculation subunit, configured to calculate, in a first direction, an accumulated stress value difference between a pixel block and an adjacent pixel block in each of the different channels based on the average accumulated stress values; and
a merging subunit, configured to: if the accumulated stress value difference is less than a preset threshold, merge the pixel block with the adjacent pixel block to obtain a reference pixel block partition, calculate the average accumulated stress value of the reference pixel block partition, and calculate an accumulated stress value difference between the reference pixel block partition and an adjacent pixel block based on the average accumulated stress values until the accumulated stress value difference is greater than or equal to the preset threshold, to obtain the target pixel block partitions in different channels and the segment accumulated stress values corresponding to the target pixel block partitions.

In an embodiment, the compression module further includes: an encoding unit, configured to encode the pixel blocks according to a preset interlaced encoding rule.

In an embodiment, the decompression module includes:
a number determination unit, configured to determine a number of pixel blocks in a target pixel block partition based on the partition length;
a pixel block calculation unit, configured to decompress the compressed image data based on the number of the pixel blocks and the segment accumulated stress value, to obtain average accumulated stress values of respective pixel blocks in each channel; and
a sub-pixel calculation unit, configured to determine the accumulated stress values of respective pixels in each channel based on the average accumulated stress values of respective pixel blocks in each channel.

In an embodiment, the decompression module further includes: a decoding unit, configured to perform linear interpolation in a second direction on the pixel blocks according to the preset interlaced encoding rule.

All or some of the modules in the foregoing image compensation apparatus may be implemented by using software, hardware, or a combination thereof. The foregoing modules may be embedded in or independent of a processor in a computer device in a hardware form, or may be stored in a memory in the computer device in a software form, so that the processor invokes and performs operations corresponding to the foregoing modules.

In an exemplary embodiment, a computer device is provided, which may be a server, and an internal structure diagram thereof may be shown in FIG. 7. The computer device includes a processor, a memory, an input/output (I/O) interface, and a communication interface. The processor, the memory, and the input/output interface are connected via a system bus, and the communication interface is connected to the system bus via the input/output interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for running of the operating system and the computer program in the non-transitory storage medium. The database of the computer device is configured to store historical accumulated stress value data. The input/output interface of the computer device is configured to exchange information between the processor and an external device. The communication interface of the computer device is configured to communicate with an external terminal through a network connection. The computer program is executed by the processor to implement an image compensation method.

A person skilled in the art may understand that the structure shown in FIG. 7 is merely a block diagram of a partial structure related to the solution of this application, and does not constitute a limitation on a computer device to which the solution of this application is applied. A specific computer device may include more or fewer components than those shown in FIG. 7, or some components can be combined, or a different component arrangement can be present.

In an exemplary embodiment, a computer device is provided, including a memory and a processor, where the memory stores a computer program, and when the processor executes the computer program, the processor performs the steps of the method in any one of the foregoing embodiments.

In an embodiment, a computer-readable storage medium is provided, where the computer-readable storage medium stores a computer program, and when the computer program is executed by a processor, the processor is caused to perform the steps of the method in any one of the foregoing embodiments.

In an embodiment, a computer program product is provided, including a computer program, where when the computer program is executed by a processor, the processor is caused to perform the steps of the method in any one of the foregoing embodiments.

A person of ordinary skill in the art may understand that all or some of the processes in the methods of the foregoing embodiments may be implemented by instructing related hardware by using a computer program, the computer program may be stored in a non-transitory computer-readable storage medium, and when the computer program is executed, the processes of the methods according to the foregoing embodiments may be included. Any reference to a memory, a database, or another medium used in the embodiments provided in this application may include at least one of a non-transitory memory and a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The transitory memory may include a random access memory (RAM), an external cache, or the like. By way of illustration and not limitation, the RAM may be in various forms, such as a static random access memory (SRAM) or a dynamic random access memory (DRAM). The database in the embodiments provided in this application may include at least one of a relational database and a non-relational database. The non-relational database may include, but is not limited to, a blockchain-based distributed database. The processor in the embodiments provided in this application may be a general-purpose processor, a central processing unit, a graphics processing unit, a digital signal processor, a programmable logic device, a data processing logic device based on quantum computing, an artificial intelligence (AI) processor, or the like, and is not limited thereto.

The technical features of the above embodiments may be arbitrarily combined, and in order to make the description concise, not all possible combinations of the technical features in the above embodiments are described; however, as long as there is no contradiction between the combinations of these technical features, it should be considered as falling into the scope of the present disclosure.

The above embodiments only express several implementations of the present application, and the description thereof is specific and detailed, but cannot be construed as limiting the scope of the present application. It should be noted that for those of ordinary skill in the art, several variations and improvements can be made without departing from the concept of the present application, which all fall within the protection scope of the present application. Therefore, the protection scope of this application shall be subject to the appended claims.

What is claimed is:

1. An image compensation method, comprising:
obtaining a to-be-processed image, the to-be-processed image carrying accumulated stress values of each pixel in different channels;
obtaining luminance decay degree values of each pixel in different channels based on the accumulated stress values; and
calculating a compensation factor for each pixel based on the luminance decay degree values of each pixel in different channels, and compensating each pixel according to the compensation factor.

2. The image compensation method according to claim 1, wherein obtaining the luminance decay degree values of each pixel in different channels based on the accumulated stress values comprises:
obtaining preset lookup tables corresponding to different channels, wherein each preset lookup table is generated based on a relationship between historical accumulated stress values and current luminance decay degrees; and
separately querying, based on the accumulated stress values, the preset lookup tables corresponding to different channels, to obtain the luminance decay degree values of each pixel in different channels.

3. The image compensation method according to claim 1, wherein calculating the compensation factor for each pixel based on the luminance decay degree values of each pixel in different channels, and compensating each pixel according to the compensation factor comprise:
determining a display status of each pixel based on the luminance decay degree values of each pixel in different channels;
in a case that the display status is that there exists a color offset, calculating a decay difference of each pixel in different channels, using the decay difference as the compensation factor, and performing color offset compensation on each pixel according to the compensation factor; and
in a case that the display status is that there exists a luminance decay, obtaining a target luminance value, using the target luminance value as the compensation factor, and performing luminance compensation on each pixel according to the compensation factor.

4. The image compensation method according to claim 3, wherein calculating the decay difference of each pixel in different channels, using the decay difference as the compensation factor, and compensating each pixel according to the compensation factor comprise:
determining a maximum decay channel and a minimum decay channel based on the luminance decay degree values of each pixel in different channels;
calculating the decay difference based on the maximum decay channel and the minimum decay channel; and
compensating a luminance value corresponding to the maximum decay channel based on the decay difference, to cause the luminance decay degree value of the maximum decay channel to be consistent with the luminance decay degree value of the minimum decay channel.

5. The image compensation method according to claim 3, wherein using the target luminance value as the compensation factor and performing luminance compensation on each pixel according to the compensation factor comprise:
compensating luminance values of each pixel in different channels based on the target luminance value.

6. The image compensation method according to claim 3, wherein a process of determining the display status comprises:
in a case that a maximum luminance decay degree value is less than a preset threshold and a difference between the maximum luminance decay degree value and a minimum luminance decay degree value is greater than a difference threshold, or in a case that the maximum luminance decay degree value is greater than the preset threshold and the minimum luminance decay degree value is less than the preset threshold, determining that the display status is that there exists the color offset; and
in a case that both the maximum luminance decay degree value and the minimum luminance decay degree value are greater than or equal to the preset threshold, determining that the display status is that there exists the luminance decay.

7. The image compensation method according to claim 2, wherein the to-be-processed image is obtained by decompressing compressed image data, and the compressed image data comprises a partition length and a segment accumulated stress value that correspond to a target pixel block partition in each channel; and
wherein before separately querying, based on the accumulated stress values, the preset lookup tables corresponding to different channels, the image compensation method further comprises:
decompressing the compressed image data based on the partition length and the segment accumulated stress value, to obtain accumulated stress values of respective pixels in each channel.

8. The image compensation method according to claim 7, wherein a compression process to obtain the compressed image data comprises:
obtaining original image data;
dividing the original image data into blocks to obtain a plurality of pixel blocks;
calculating average accumulated stress values of each pixel block in different channels based on the accumulated stress values of respective pixels in each pixel block in different channels;
merging the pixel blocks in different channels based on the average accumulated stress values of each pixel block in different channels, to obtain target pixel block partitions in different channels and segment accumulated stress values corresponding to the target pixel block partitions; and
performing compression based on numbers of pixel blocks corresponding to the target pixel block partitions in different channels and the segment accumulated stress values corresponding to the target pixel block partitions in different channels, to obtain the compressed image data.

9. The image compensation method according to claim 8, wherein merging the pixel blocks in different channels based on the average accumulated stress values of each pixel block in different channels, to obtain the target pixel block partitions in different channels and the segment accumulated stress values corresponding to the target pixel block partitions comprises:
calculating, in a first direction, an accumulated stress difference between a pixel block and an adjacent pixel block in each of the different channels based on the average accumulated stress values; and
in a case that the accumulated stress difference is less than a preset threshold, merging the pixel block with the adjacent pixel block to obtain a reference pixel block partition, and calculating the average accumulated stress value of the reference pixel block partition; and
calculating an accumulated stress value difference between the reference pixel block partition and an adjacent pixel block based on the average accumulated stress values until the accumulated stress value difference is greater than or equal to the preset threshold, to obtain the target pixel block partitions in different channels and the segment accumulated stress values corresponding to the target pixel block partitions.

10. The image compensation method according to claim 8, wherein after dividing the original image data into blocks to obtain the plurality of pixel blocks, the image compensation method comprises:
encoding the pixel blocks according to a preset interlaced encoding rule.

11. The image compensation method according to claim 8, wherein decompressing the compressed image data based on the partition length and the segment accumulated stress value, to obtain the accumulated stress values of respective pixels in each channel comprises:
determining a number of pixel blocks in a target pixel block partition based on the partition length;
decompressing the compressed image data based on the number of the pixel blocks and the segment accumulated stress value, to obtain average accumulated stress values of respective pixel blocks in each channel; and
determining the accumulated stress values of respective pixels in each channel based on the average accumulated stress values of respective pixel blocks in each channel.

12. The image compensation method according to claim 10, wherein after obtaining average accumulated stress values of respective pixel blocks in each channel, the image compensation method comprises:
performing linear interpolation in a second direction on the pixel blocks according to the preset interlaced encoding rule.

13. An image compensation apparatus, comprising:
an obtaining module, configured to obtain a to-be-processed image, wherein the to-be-processed image carries accumulated stress values of each pixel in different channels;
a decay determination module, configured to obtain luminance decay degree values of each pixel in different channels based on the accumulated stress values; and
a compensation module, configured to calculate a compensation factor for each pixel based on the luminance decay degree values of each pixel in different channels, and compensate each pixel according to the compensation factor.

14. A computer device, comprising a memory and a processor, wherein the memory stores a computer program therein, and the processor, when executing the computer program, performs steps of the image compensation method according to claim 1.

15. A non-transitory computer-readable storage medium, having a computer program stored thereon, wherein the computer program, when executed by a processor, causes the processor to perform steps of the image compensation method according to claim 1.

16. A computer program product, comprising a computer program, wherein the computer program, when executed by a processor, causes the processor to perform steps of the image compensation method according to claim 1.
